(19) United States
(12) Patent Application Publication
(10) Pub. No.: US 2025/0270038 A1
(43) Pub. Date: Aug. 28, 2025

(54) THREE-DIMENSIONAL STORAGE SYSTEM

(71) Applicant: CHAINT CORPORATION, CHANGSHA (CN)

(72) Inventors: PU YAN, CHANGSHA (CN); RONG LIU, CHANGSHA (CN); MIN LONG, CHANGSHA (CN); YONG HE, CHANGSHA (CN); DINGHAO LIU, CHANGSHA (CN); XUDONG ZHANG, CHANGSHA (CN)

(73) Assignee: CHAINT CORPORATION, CHANGSHA (CN)

(21) Appl. No.: 19/199,383

(22) Filed: May 6, 2025

Related U.S. Application Data
(63) Continuation of application No. PCT/CN2023/089254, filed on Apr. 19, 2023.

(30) Foreign Application Priority Data
Nov. 29, 2022 (CN) 202223184234.5

(51) Int. Cl. B65G 1/04; B65G 37/02

(52) U.S. Cl. CPC B65G 1/0407; B65G 1/0485; B65G 37/02; B65G 2812/14

(57) ABSTRACT

The present application discloses a three-dimensional storage system including a three-dimensional warehouse, stacker cranes, side conveying devices, and central conveying devices. The three-dimensional warehouse comprises N groups of side-by-side arranged three-dimensional storage units, each group of the three-dimensional storage units including two rows of racks arranged at intervals. The N stacker cranes are respectively arranged in the aisles of the N groups of three-dimensional storage units in a one-to-one correspondence. Two side conveying devices are respectively disposed at the ends of the outermost rows of racks in the three-dimensional warehouse. The central conveying devices are arranged at the ends of the two rows of racks between adjacent aisles. One central conveying device is shared between each pair of adjacent three-dimensional storage units, thereby reducing the number of devices, which in turn lowers operating costs and facilitates later maintenance.

### CROSS REFERENCES TO RELATED APPLICATIONS

This application is the U.S. national stage of international application No. PCT/CN2023/089254, titled “Three-Dimensional Storage System”, filed on Apr. 19, 2023, which claims priority to Chinese Patent Application No. 202223184234.5, titled “Three-Dimensional Storage System,” filed on Nov. 29, 2022, the entire contents of aforementioned applications are hereby incorporated by reference in their entirety.

### TECHNICAL FIELD

The present application relates to the field of warehousing technology, and more particularly to a three-dimensional storage system.

### BACKGROUND

At present, cylindrical materials such as paper rolls, fabric rolls, film rolls, and bar stock are mostly stored using three-dimensional warehouses in order to improve space utilization and effectively save limited and valuable land resources. Existing three-dimensional warehouses typically include multiple groups of side-by-side arranged three-dimensional storage units. Each group of three-dimensional storage units includes two rows of racks arranged at intervals. An aisle is formed between the two rows of racks in each group of three-dimensional storage units, and a stacker crane operates within the aisle to store and retrieve materials from the racks. In order to avoid interference between inbound and outbound operations and to improve takt time and efficiency, each group of three-dimensional storage units is equipped with an inbound conveying module and an outbound conveying module, which are respectively arranged on both sides of the aisle.

### TECHNICAL PROBLEM

One of the objectives of the embodiments of the present application is to provide a three-dimensional storage system.

### TECHNICAL SOLUTION

The technical solution adopted by the embodiments of the present application is as follows:

A three-dimensional storage system is provided. The three-dimensional storage system includes:
a three-dimensional warehouse, comprising N groups of side-by-side arranged three-dimensional storage units, each group of the three-dimensional storage units comprising two rows of racks arranged at intervals, an aisle being formed between the two rows of racks in each group of the three-dimensional storage units, wherein N is a natural number greater than 1;
N stacker cranes, each correspondingly arranged in the aisle of one of the N groups of three-dimensional storage units, the stacker cranes being configured to store and retrieve cylindrical materials on the racks;
two side conveying devices, respectively arranged at the ends of the outermost rows of racks in the three-dimensional warehouse, the side conveying devices being connectable to the stacker cranes in the adjacent aisles; and
N-1 central conveying devices, each arranged at the ends of two rows of racks between adjacent aisles and connectable to the stacker cranes in the adjacent aisles.

In one embodiment, the central conveying device comprises:
a central conveyor, located at the end of one of the rows of racks and connectable to the stacker crane in the adjacent aisle; and
a transfer conveyor, located at the end of the other row of racks and configured to transfer cylindrical materials between the central conveyor and the stacker crane in the aisle adjacent to the transfer conveyor.

In one embodiment, the central conveyor comprises:
a rail, arranged parallel to the length direction of the aisle;
a traveling mechanism, arranged on the rail and movable along the length direction of the rail; and
a first conveyor, arranged on the traveling mechanism, the conveying direction of the first conveyor being perpendicular to the length direction of the rail.

In one embodiment, the number of the traveling mechanisms and the first conveyors is two, and the two first conveyors are respectively arranged on the two traveling mechanisms in a one-to-one correspondence.

In one embodiment, the side conveying device has the same structure as the central conveying device.

In one embodiment, the transfer conveyor comprises:
a frame; and
a second conveyor, mounted on the frame, the conveying direction of the second conveyor being perpendicular to the length direction of the rail.

In one embodiment, the system further comprises a main conveyor line, and the main conveyor line connects the side conveying devices and the central conveying devices in series.

In one embodiment, the system further comprises:
an inbound conveyor line, connected to one end of the main conveyor line; and
a return conveyor line, connected to one side of one of the side conveying devices.

In one embodiment, the inbound conveyor line comprises, in sequence along the conveying direction of the material, a loading device, a label scanning device, an information verification device, an RFID scanning device, and a rotary conveyor.

In one embodiment, the return conveyor line comprises, in sequence along the conveying direction of the material, an RFID scanning device, a labeling device, and an information verification device.

### ADVANTAGEOUS EFFECTS

The advantageous effects of the three-dimensional storage system provided by the embodiments of the present application lie in that the three-dimensional storage system includes a central conveying device disposed at the ends of two rows of racks between adjacent aisles. The central conveying device is connectable to the two stacker cranes in the adjacent aisles, allowing a single central conveying device to be shared between adjacent three-dimensional storage units.

### BRIEF DESCRIPTION OF THE DRAWINGS

In order to more clearly illustrate the technical solutions in the embodiments of the present application, a brief description of the drawings used in the embodiments or in the description of the exemplary technologies is provided below. It is evident that the drawings described below are merely some embodiments of the present application, and those skilled in the art may derive other drawings based on these drawings without any inventive effort.

FIG. 1 is a top view schematic structural diagram of the three-dimensional storage system provided in the embodiments of the present application;

FIG. 2 is a side view of the central conveying device provided in the embodiments of the present application;

FIG. 3 is a schematic structural diagram of the central conveyor in the central conveying device provided in the embodiments of the present application;

FIG. 4 is a schematic structural diagram of the end of the transfer conveyor in the central conveying device provided in the embodiments of the present application;

FIG. 5 is a top view schematic structural diagram of the inbound conveyor line in the three-dimensional storage system provided in the embodiments of the present application;

FIG. 6 is a side view schematic structural diagram of the inbound conveyor line shown in FIG. 5;

FIG. 7 is a schematic structural diagram of the rotary loading platform of the loading device in the inbound conveyor line shown in FIG. 6;

FIG. 8 is a schematic structural diagram of the material distributing platform of the loading device in the inbound conveyor line shown in FIG. 6;

FIG. 9 is a partial schematic structural diagram of the label scanning device in the inbound conveyor line;

FIG. 10 is a top view schematic structural diagram of another loading device in the inbound conveyor line provided in the embodiments of the present application;

FIG. 11 is a schematic structural diagram of the vertical lifter in the loading device shown in FIG. 10 provided in the embodiments of the present application;

FIG. 12 is a schematic structural diagram of the labeling device provided in the embodiments of the present application;

FIG. 13 is a partial schematic structural diagram of the label scanning device provided in the embodiments of the present application;

FIG. 14 is a schematic structural diagram of the RFID scanning device provided in the embodiments of the present application; and

FIG. 15 is a top view schematic structural diagram of an existing three-dimensional warehouse.

### DETAILED DESCRIPTION

In order to make the objectives, technical solutions, and advantages of the present application more clearly understood, the following provides a detailed description of the present application with reference to the accompanying drawings and embodiments. It should be understood that the specific embodiments described herein are merely intended to illustrate the present application and are not intended to limit it.

It should be noted that when a component is described as being “fixed to” or “disposed on” another component, it may be directly on or indirectly on the other component. When a component is described as being “connected to” another component, it may be directly or indirectly connected to the other component. Terms such as “upper,” “lower,” “left,” “right,” and similar directional or positional indicators are based on the orientations or positional relationships shown in the drawings, and are intended for convenience of description only. They are not intended to indicate or imply that the referenced devices or components must have a specific orientation or be constructed and operated in a specific orientation, and therefore should not be construed as limiting the present application. Those of ordinary skill in the art will understand the specific meaning of the above terms in view of the particular context. The terms “first” and “second” are used solely for the purpose of distinguishing elements and should not be construed as indicating or implying relative importance or the quantity of technical features. The term “multiple” means two or more, unless explicitly specified otherwise.

It should also be noted that in the embodiments of the present application, the same reference numerals are used to indicate the same components or parts. In some figures, only one of several identical components or parts may be labeled with a reference numeral as an example. It should be understood that the same reference numerals apply to the other identical components or parts as well.

To further explain the technical solutions provided by the present application, a detailed description is given below in conjunction with specific drawings and embodiments.

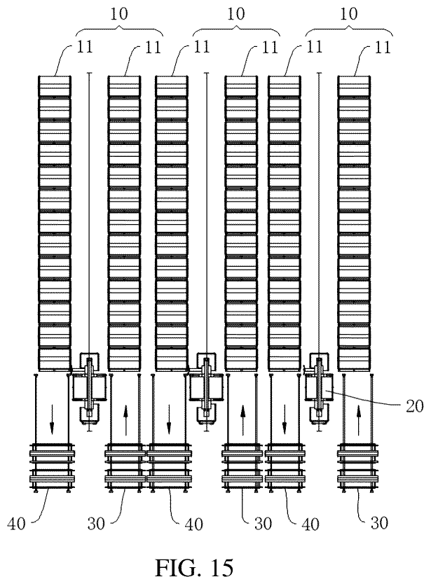

As shown in FIG. 15, an existing three-dimensional warehouse includes multiple groups of side-by-side arranged three-dimensional storage units 10. Each group of three-dimensional storage units 10 includes two rows of racks 11 arranged at intervals. An aisle is formed between the two rows of racks 11 in each group of three-dimensional storage units 10. A stacker crane 20 operates within the aisle to store and retrieve materials from the racks 11. Each group of three-dimensional storage units 10 is equipped with an inbound conveying module 30 and an outbound conveying module 40, which are respectively disposed at the ends of the two rows of racks. Because the number of three-dimensional storage units 10 in the warehouse is large, equipping each group with one inbound conveying module 30 and one outbound conveying module 40 results in a large number of devices in the entire three-dimensional storage system, increasing operational costs and making maintenance more difficult.

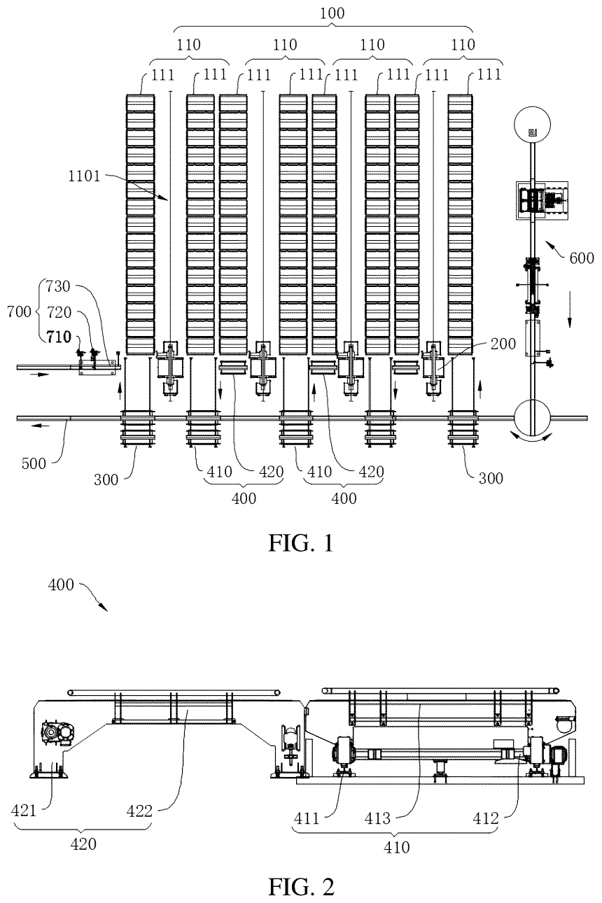

To address the above problem, an embodiment of the present application provides a three-dimensional storage system. As shown in FIG. 1, the three-dimensional storage system includes a three-dimensional warehouse 100, N stacker cranes 200, two side conveying devices 300, and N-1 central conveying devices 400.

The three-dimensional warehouse 100 includes N groups of side-by-side arranged three-dimensional storage units 110. Each group of three-dimensional storage units 110 includes two rows of racks 111 arranged at intervals. An aisle 1101 is formed between the two rows of racks 111 in each group of three-dimensional storage units 110, wherein N is a natural number greater than 1. The N stacker cranes 200 are respectively arranged in the aisles 1101 of the N groups of three-dimensional storage units 110 in a one-to-one correspondence. The stacker cranes 200 are configured to store and retrieve cylindrical materials on the racks 111. The two side conveying devices 300 are respectively arranged at the ends of the outermost rows of racks 111 in the three-dimensional warehouse 100. The side conveying devices 300 are connectable to the stacker cranes 200 in the adjacent aisles 1101. The central conveying devices 400 are arranged at the ends of the two rows of racks 111 between adjacent aisles 1101 and are connectable to the two stacker cranes 200 in the adjacent aisles 1101.

In the embodiment of the present application, the three-dimensional storage system includes a central conveying device 400 disposed at the ends of two rows of racks 111 between adjacent aisles 1101. The central conveying device 400 is connectable to the two stacker cranes 200 in the adjacent aisles 1101, such that one central conveying device 400 is shared between adjacent three-dimensional storage units 110. As a result, the number of devices in the three-dimensional storage system can be reduced, thereby lowering operational costs and facilitating maintenance.

It is understood that the side conveying devices 300 and the central conveying devices 400 serve the function of delivering materials to the adjacent stacker cranes 200 for inbound storage, or receiving outbound materials from the stacker cranes 200 for delivery out of the system. To ensure clear inbound and outbound material flow within each group of three-dimensional storage units 110, and to enhance takt time and efficiency, one of the side conveying devices 300 or the central conveying devices 400 on either side of each aisle 1101 is designated as the inbound fork platform, and the other as the outbound fork platform.

Each row of racks 111 is a three-dimensional frame structure composed of at least two vertical plates and several horizontal plates. The horizontal plates form multiple levels for placing cylindrical materials. Each horizontal plate is provided with a base. The base is a plate-shaped member, and its upper surface is provided with a V-shaped groove configured to limit the rolling of cylindrical materials. The two fork arms on the fork of the stacker crane 200 are spaced apart, allowing cylindrical materials to be picked up by extending and retracting the fork.

In one embodiment, as shown in FIGS. 1 and 2, the central conveying device 400 includes a central conveyor 410 and a transfer conveyor 420. The central conveyor 410 is located at the end of one of the rows of racks 111 and is connectable to the stacker crane 200 in the adjacent aisle 1101. The transfer conveyor 420 is located at the end of the other row of racks 111 and is configured to transfer cylindrical materials between the central conveyor 410 and the stacker crane 200 in the aisle 1101 adjacent to the transfer conveyor 420.

With this configuration, the central conveyor 410 may deliver inbound materials to or receive outbound materials from the stacker crane 200 in the adjacent aisle 1101. The transfer conveyor 420 bridges the distance between the central conveyor 410 and the stacker crane 200 on the side away from the central conveyor 410. Thus, in cooperation, the central conveyor 410 and the transfer conveyor 420 can deliver inbound materials to or receive outbound materials from the stacker crane 200 on the side remote from the central conveyor 410. This enables one central conveying device 400 to be shared between adjacent three-dimensional storage units 110, thereby reducing operational costs.

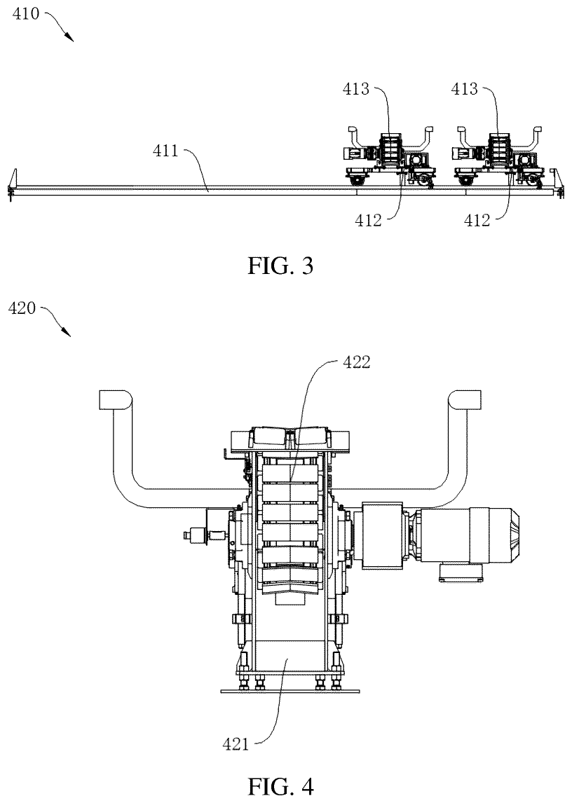

In a specific embodiment, as shown in FIGS. 2 and 3, the central conveyor 410 includes rails 411, a traveling mechanism 412, and a first conveyor 413.

The rails 411 are arranged parallel to the longitudinal direction of the aisle 1101. The traveling mechanism 412 is arranged on the rails 411 and is movable along the longitudinal direction of the rails 411. The first conveyor 413 is arranged on the traveling mechanism 412, and the conveying direction of the first conveyor 413 is perpendicular to the longitudinal direction of the rails 411.

Specifically, there are two rails 411, arranged in parallel and spaced apart. The traveling mechanism 412 includes a carriage and a drive roller, an idler roller, and a drive motor mounted on the carriage. The drive roller and idler roller are both in rolling contact with the rails 411. The drive motor is connected to the drive roller through a transmission mechanism and is used to drive the rotation of the drive roller, thereby enabling the traveling mechanism 412 to move along the rails 411.

In a more specific embodiment, as shown in FIGS. 1 and 3, the number of traveling mechanisms 412 and the number of first conveyors 413 are both two. The two first conveyors 413 are respectively arranged on the two traveling mechanisms 412 in a one-to-one correspondence.

It is understood that one traveling mechanism 412 and one first conveyor 413 constitute a mobile conveyor that is movable along the rails. With this configuration, the number of mobile conveyors is increased. In the case where the main conveyor line 500 connects each side conveying device 300 and each central conveying device 400 in series, the arrangement of two mobile conveyors allows one to move along the rails 411 to transfer materials while the other fills the gap in the main conveyor line 500 at the position of the rails 411, ensuring continuity of the main conveyor line 500.

In a specific embodiment, as shown in FIG. 1, the side conveying device 300 has the same structure as the central conveyor 410.

With this configuration, production, processing, installation, and maintenance are facilitated.

In a more specific embodiment, as shown in FIGS. 2 and 4, the transfer conveyor 420 includes a frame 421 and a second conveyor 422 mounted on the frame 421. The conveying direction of the second conveyor 422 is perpendicular to the longitudinal direction of the rails 411.

With this configuration, the second conveyor 422 of the transfer conveyor 420 can be aligned with the stacker crane 200 and the first conveyor 413 of the central conveyor 410, thereby enabling smooth transfer of cylindrical materials among the central conveyor 410, the transfer conveyor 420, and the stacker crane 200.

It should be noted that in the embodiments of the present application, both the first conveyor 413 and the second conveyor 422 are chain plate conveyors. The conveying plates of the chain plate conveyors have a V-shaped surface, which facilitates the efficient and continuous transport of cylindrical materials.

In some embodiments, as shown in FIG. 1, the three-dimensional storage system further includes a main conveyor line 500, which connects each of the side conveying devices 300 and each of the central conveying devices 400 in series.

With the above configuration, the main conveyor line 500 serves two functions. On one hand, it can distribute inbound materials to the appropriate side conveying device 300 or central conveying device 400 corresponding to the designated rack 111. On the other hand, it can aggregate all outbound materials onto a single conveyor line for unified external output.

Specifically, the main conveyor line 500 may be formed by multiple sections of chain plate conveyors. The side conveying devices 300 and central conveying devices 400 are connected in series by the multiple sections of chain plate conveyors. The conveying plates of each section of the chain plate conveyor have a V-shaped surface, facilitating the efficient and continuous transport of cylindrical materials.

In some specific embodiments, as shown in FIG. 1, the three-dimensional storage system further includes an inbound conveyor line 600 connected to one end of the main conveyor line 500 and a return conveyor line 700 connected to one side of one of the side conveying devices 300.

Taking cylindrical paper rolls as an example, the paper rolls include original paper rolls and remaining rolls. The original paper rolls are raw paper rolls used for further processing into various types of paper. During the processing, the rolls are used according to production orders. Since the entire roll is not always consumed due to order quantity, residual portions remain, forming remaining rolls.

With the above configuration, the remaining rolls can be transferred via the return conveyor line 700 to one of the side conveying devices 300, then delivered by the side conveying device 300 to the adjacent stacker crane 200, and finally stored on the rack 111 by the stacker crane 200. The original paper rolls can be delivered via the inbound conveyor line 600 to the main conveyor line 500, and then transferred to the stacker crane 200 via a central conveying device 400 or another side conveying device 300, and finally stored on the rack 111 in the three-dimensional warehouse 100 by the stacker crane 200. As described above, the inbound routes for original paper rolls and remaining rolls can be mutually independent and non-interfering.

In some specific embodiments, as shown in FIGS. 1, 5, and 6, the inbound conveyor line 600 includes, in sequence along the material conveying direction (as indicated by the arrow in the figure), a loading device 610, a label scanning device 620, an information verification device 630, an RFID scanning device 640, and a rotary conveyor device 650.

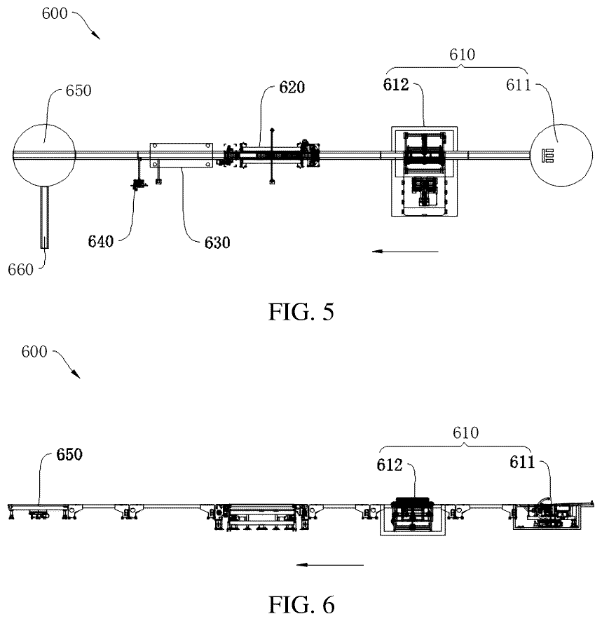

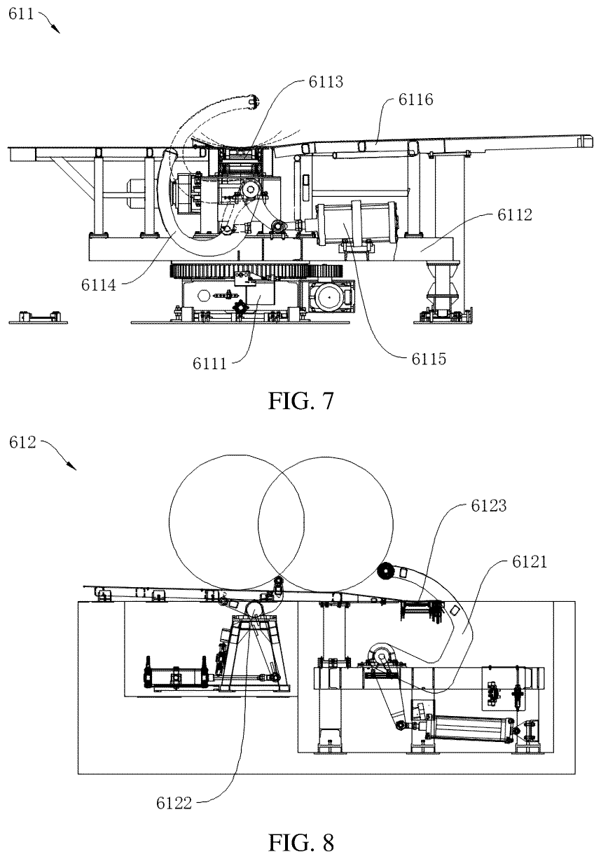

Specifically, in one implementation, as shown in FIGS. 5 through 8, the loading device 610 includes a rotary loading platform 611 and a material distribution platform 612 arranged sequentially along the material conveying direction. The rotary loading platform 611 includes a rotary drive mechanism 6111, a carrier frame 6112 mounted on the rotary drive mechanism 6111, and a third conveyor 6113, a buffer swing arm 6114, a telescopic actuator 6115, and a loading ramp 6116 all mounted on the carrier frame 6112. The loading ramp 6116 is inclined on one side of the third conveyor 6113 in the conveying direction, with the lower end (i.e., the end at a lower position) of the ramp connected to one side of the third conveyor 6113 in the conveying direction. The buffer swing arm 6114 moves under the action of the telescopic actuator 6115 between a position above the third conveyor 6113 and the side of the third conveyor 6113 opposite the loading ramp 6116. Cylindrical materials are placed at the higher end of the loading ramp 6116 by transfer equipment such as forklifts or clamp trucks and roll down under their own weight to the third conveyor 6113. The buffer swing arm 6114 acts under the telescopic actuator 6115 to buffer and stop the rolling material, causing the cylindrical material to finally rest on the third conveyor 6113. The material distribution platform 612 includes a kicker 6121, a distributor 6122, and a fourth conveyor 6123. The distributor 6122 and fourth conveyor 6123 are arranged on an inclined ramp, with the distributor 6122 positioned midway along the ramp and the fourth conveyor 6123 located at the lower end. Under the force of gravity, cylindrical materials placed on the ramp roll from the higher to the lower end. While the fourth conveyor 6123 is conveying materials, the distributor 6122 pushes out materials cached on the ramp. When there are no materials on the fourth conveyor 6123, the kicker 6121 extends to receive a material unit. The distributor 6122 allows the first cached material to roll down while blocking the second and caching the rest. After receiving the material, the kicker 6121 retracts slowly to transfer the material to the fourth conveyor 6123, and the distributor 6122 resets, completing the loading process.

Using the above-described loading device 610, materials from a flatbed truck can be placed on the material distribution platform 612, and materials from a container can be placed on the rotary loading platform 611. After rotation by the rotary loading platform 611, materials from both types of vehicles can share a single conveyor line. This setup meets the unloading needs of both flatbed trucks and containers, reduces the need for additional weighing and detection equipment, maximizes the use of space, and lowers costs.

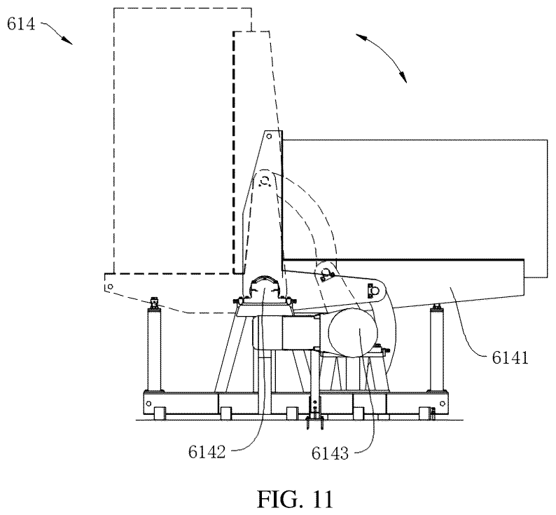

In another implementation, as shown in FIGS. 10 and 11, the loading device 610 includes a dual-row chain plate conveyor 613 and a vertical lifter 614, arranged sequentially along the material conveying direction (indicated by arrows in the drawings). The vertical lifter 614 includes an L-shaped flipping frame 6141, a rotating shaft 6142, and a flipping drive mechanism 6143. The L-shaped flipping frame 6141 is rotatably mounted on a base via the rotating shaft 6142. The flipping drive mechanism 6143 is used to flip the long side of the L-shaped frame 6141 between a horizontal position and a vertical position.

With the above-described loading device 610, cylindrical materials can be loaded upright, allowing for a uniform unloading platform height across different types of vehicles.

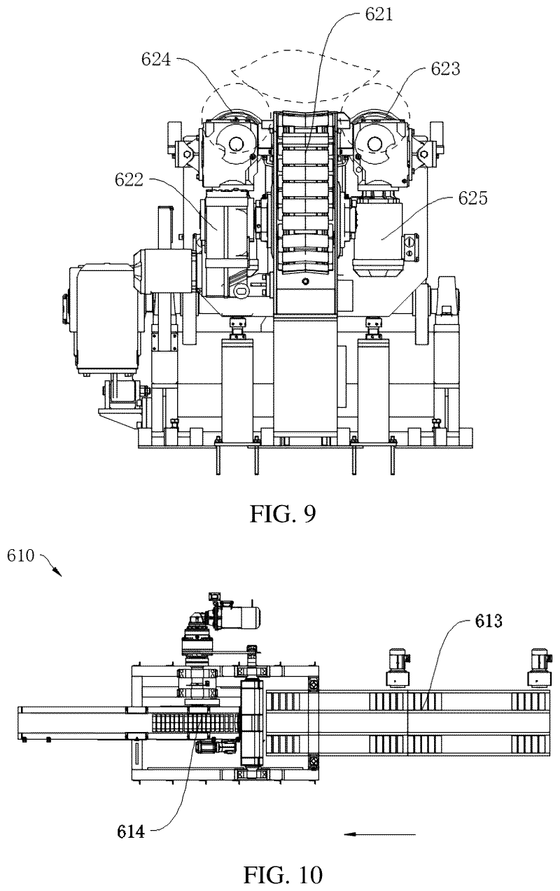

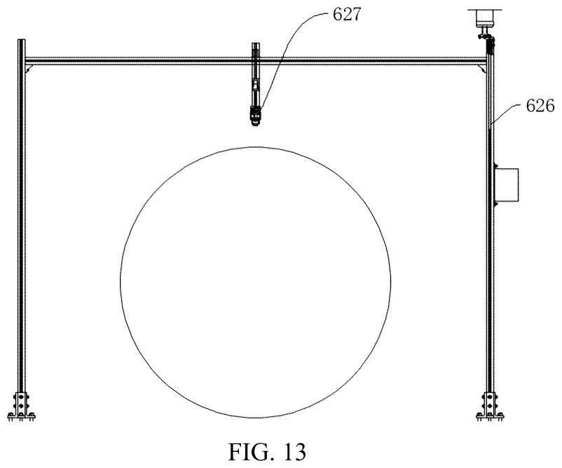

The label scanning device 620 is used to scan paper labels attached to the materials. As shown in FIGS. 9 and 13, the label scanning device 620 includes a fifth conveyor 621, a lifting mechanism 622, a driving roller 623, an idler roller 624, a roller drive mechanism 625, a scanning bracket 626, and a scanner 627. The lifting mechanism 622 is disposed outside the fifth conveyor 621. The driving roller 623 and idler roller 624 are located on opposite sides of the fifth conveyor 621 along the conveying direction and are both mounted on the lifting mechanism 622. The roller drive mechanism 625 drives the rotation of the driving roller 623. The scanning bracket 626 is positioned above the fifth conveyor 621, and the scanner 627 is mounted on the scanning bracket 626. Under the action of the lifting mechanism 622, the driving roller 623 and the idler roller 624 lift the cylindrical material on the fifth conveyor 621 (as indicated by dashed lines in FIG. 9), and the roller drive mechanism 625 rotates the driving roller 623 to turn the cylindrical material until the scanner 627 reads the paper label on the outer circumferential surface of the cylindrical material.

The information verification device 630 is configured to detect the weight, diameter, and width of the cylindrical materials to be stored.

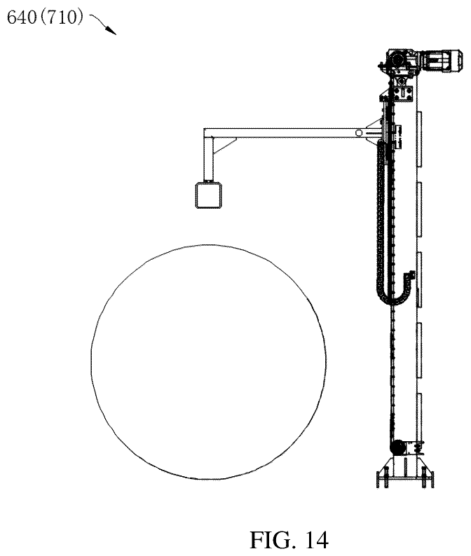

The RFID scanning device 640 is configured to scan RFID (Radio Frequency Identification) tags installed on the cylindrical materials to be stored. As shown in FIG. 14, the RFID scanning device 640 includes a lifting bracket and an RFID scanner 627 mounted on the lifting bracket and capable of vertical movement.

The rotary conveying device 650 may be a turntable-type chain plate conveyor. By utilizing the rotary conveying device 650, a perpendicular arrangement between the inbound conveyor line 600 and the main conveyor line 500 can be achieved.

The inbound conveyor line 600 further includes an abnormal discharge conveyor line 660. The abnormal discharge conveyor line 660 is disposed on one side of the rotary conveying device 650 and is used to discharge abnormal materials.

Specifically, the third conveyor 6113, fourth conveyor 6123, and fifth conveyor 621 may all be chain plate conveyors. Of course, other conveying mechanisms may also be used and are not limited herein.

In some specific embodiments, as shown in FIG. 1, the return conveyor line 700 includes, in sequence along the material conveying direction (as indicated by arrows in the figure), an RFID scanning device 710, a labeling device 720, and an information verification device 730.

The RFID scanning device 710 is configured to scan RFID (Radio Frequency Identification) tags installed on the cylindrical materials to be returned to storage.

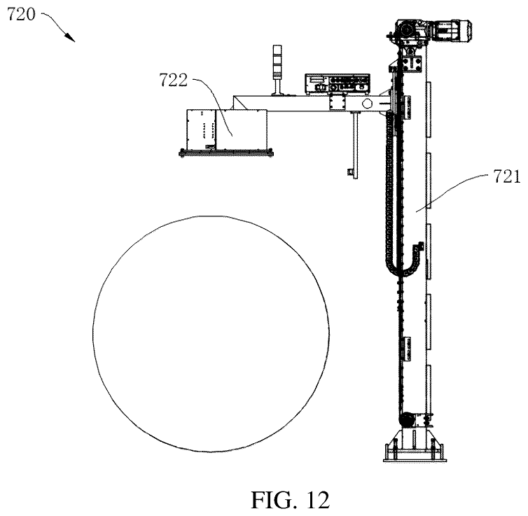

The labeling device 720 is configured to attach paper labels to the materials to be returned. As shown in FIG. 12, the labeling device 720 includes a labeling bracket 721 and a label applicator 722 mounted on the labeling bracket 721 and movable along the height direction of the bracket.

The information verification device 730 is configured to detect the width of the materials to be returned to storage and to update the weight and diameter information to the RFID.

The above descriptions are merely optional embodiments of the present application and are not intended to limit the present application. Various modifications and changes can be made to the present application by those skilled in the art. Any modifications, equivalent replacements, or improvements made within the spirit and principle of the present application shall fall within the scope of the claims of the present application.

1. A three-dimensional storage system, characterized by comprising:
a three-dimensional warehouse, comprising N groups of side-by-side arranged three-dimensional storage units, each group of the three-dimensional storage units comprising two rows of racks arranged at intervals, an aisle being formed between the two rows of racks of each group of the three-dimensional storage units, wherein N is a natural number greater than 1;
N stacker cranes, each correspondingly arranged in the aisle of one of the N groups of the three-dimensional storage units, the stacker cranes being configured to store and retrieve cylindrical materials on the racks;
two side conveying devices, respectively arranged at two ends of two outermost rows of racks in the three-dimensional warehouse, each side conveying device being connectable to the stacker crane in the adjacent aisle; and
N-1 central conveying devices, each arranged at an end of the two rows of racks between adjacent aisles, and connectable to the two stacker cranes in the adjacent aisles.

2. The three-dimensional storage system according to claim 1, characterized in that each of the central conveying devices comprises:
a central conveyor, located at an end of one of the rows of racks, the central conveyor being connectable to the stacker crane in the adjacent aisle; and
a transfer conveyor, located at an end of the other row of racks, the transfer conveyor being configured to transfer cylindrical materials between the central conveyor and the stacker crane in the aisle adjacent to the transfer conveyor.

3. The three-dimensional storage system according to claim 2, characterized in that the central conveyor comprises:
a rail, arranged parallel to a longitudinal direction of the aisle;
a traveling mechanism, arranged on the rail and movable along a longitudinal direction of the rail; and
a first conveyor, arranged on the traveling mechanism, a conveying direction of the first conveyor being perpendicular to the longitudinal direction of the rail.

4. The three-dimensional storage system according to claim 3, characterized in that the number of the traveling mechanisms and the first conveyors is two, and the two first conveyors are respectively arranged on the two traveling mechanisms in a one-to-one correspondence.

5. The three-dimensional storage system according to claim 3, characterized in that the side conveying device has the same structure as the central conveyor.

6. The three-dimensional storage system according to claim 3, characterized in that the transfer conveyor comprises:
a frame; and
a second conveyor, mounted on the frame, a conveying direction of the second conveyor being perpendicular to the longitudinal direction of the rail.

7. The three-dimensional storage system according to claim 6, characterized by further comprising a main conveyor line, the main conveyor line connecting each of the side conveying devices and each of the central conveying devices in series.

8. The three-dimensional storage system according to claim 7, characterized by further comprising:
an inbound conveyor line, connected to one end of the main conveyor line; and
a return conveyor line, connected to one side of one of the side conveying devices.

9. The three-dimensional storage system according to claim 8, characterized in that the inbound conveyor line comprises, in sequence along a material conveying direction, a loading device, a label scanning device, an information verification device, an RFID scanning device, and a rotary conveying device.

10. The three-dimensional storage system according to claim 8, characterized in that the return conveyor line comprises, in sequence along a material conveying direction, an RFID scanning device, a labeling device, and an information verification device.
